(19) United States
(12) Patent Application Publication
(10) Pub. No.: US 2010/0181538 A1
(43) Pub. Date: Jul. 22, 2010

(54) COATED SUSCEPTOR FOR A HIGH-TEMPERATURE FURNACE AND FURNACE COMPRISING SUCH A SUSCEPTOR

(76) Inventor: Peter Jeney, Zug (CH)

Correspondence Address: MCCORMICK, PAULDING & HUBER LLP, CITY PLACE II, 185 ASYLUM STREET, HARTFORD, CT, 06103, US

(21) Appl. No.: 12/668,692

(22) PCT Filed: Jul. 13, 2007
(86) PCT No.: PCT/EP07/57265

§ 371 Date: Jan. 12, 2010

(51) Int. Cl. C01B 3/38; B01J 19/00; F23G 5/00

(52) U.S. Cl. 252/373; 422/198; 110/235

(57) ABSTRACT

A high-temperature furnace (10) with a wall (1) or chamber defining an inner zone (8), said wall (1) or chamber comprising a refractory material, characterized in that said refractory material comprises molybdenum or a molybdenum compound being protected against oxygen in said inner zone (8) by means of a protective Silicon-Boron (S—B) coating.

The invention relates to high-temperature furnaces and in particular to induction furnaces which are particularly suitable for the disposal of waste materials and/or biomass by high temperature thermal degradation, although they may be used in other applications, such as for example roasting of ores and minerals. The invention also specifically relates to a coating for high-temperature furnaces.

Electrically powered furnaces in which heat is produced by electrical induction are well-known. The basic structure of such furnaces comprises an electrical coil within which is placed a susceptor.

The passage of alternating electrical current through the coil produces heat in the susceptor which is used to heat the furnace. A preferred material for the susceptor theoretically would be graphite. In practical applications, like the present invention metals and in particular noble metals, are used. However, particularly at high temperatures, unprotected susceptors, no matter what materials are being used, are attacked by oxygen and thereby eroded and/or oxidized in use and therefore are unsuitable for use in a furnace for prolonged use at high temperatures unless oxygen is totally excluded from the furnace. Nevertheless, there are applications of such furnaces where it is either not possible to exclude oxygen or oxygen-releasing materials, or where it is advantageous in the application to use controlled amounts of oxygen or other oxidizing materials.

Attempts have been made to solve this problem by chemical doping of the susceptor material, but these have not been entirely satisfactory.

It has also been known to use various refractory materials for the purposes of heat insulation or heat shielding in induction furnaces. An example of an inductive furnace is disclosed in the European patent EP 1495276 B1.

The problem of oxygen attack may also be observed at the walls or chamber of other directly or indirectly heated furnaces or reactors, such as annealing furnaces or combustion furnaces which reach fairly high temperatures.

The present invention seeks to provide a susceptor, reactor or furnace wall or furnace chamber coated or treated with materials which can withstand prolonged use at high temperatures in the presence of oxygen.

The present invention, accordingly provides a susceptor, reactor or furnace wall or furnace chamber wherein a protective structure is provided which comprises a molybdenum compound, respectively a molybdenum-based susceptor (e.g. a susceptor comprising a molybdenum alloy), and a Silicon-Boron (SiB) compound coating, respectively a Silicon-Boron-based coating layer.

The present invention further provides a specific coating for usage on a molybdenum susceptor, reactor or furnace wall or furnace chamber, said coating comprising a Silicon-Boron compound, respectively a Silicon-Boron-based layer.

The present invention further provides the use of a susceptor, reactor or furnace wherein said coating is employed as protective measure in the high-temperature treatment of waste materials, plants, wood or other kind of biomass, or high-temperature roasting of ores and minerals.

The coating material to be used in the present invention is a compound, preferably a Silicon-Boron compound or to be sintered onto a molybdenum comprising susceptor to protect it against oxidation.

The advantage of this/these material/s in combination with molybdenum comprising susceptors, reactors or furnaces lies in the fact that it has properties surpassing any other materials hitherto used. This chemical resistance of the proposed material combination does not require any other internal surface protection layers for most applications and the materials mentioned are withstanding high stress levels at elevated temperatures between 800° C. and 1700° C.

In a further preferred embodiment of the present invention, the coating material can be embedded within a refractory material which forms the wall or chamber of the susceptor, reactor or furnace. The term “embedded” In the context of the present invention refers to the inclusion of the coating material in the walls of the refractory material.

Preferably, between the susceptor material and the coating material a diffusion or interface region is created so that the protective coating material cannot crack or brake when the susceptor material expands under heat.

In a preferred embodiment, the coating material is applied (e.g. deposited) onto the material which forms the wall or chamber of the susceptor, reactor or furnace. After the application or deposition of the coating material, the coating material is connected or aggregated with the susceptor material by means of sintering.

The refractory material to be used for chemically aggressive materials in the present invention is preferably chemical resistant, has high thermal shock resistance, a low coefficient of thermal expansion and refractoriness at least up to 1700° C. High purity metals, such as noble metals for instance, are particularly suitable although it is envisaged that other suitable materials, such as advanced plasma sprayed composites can be used. Best results have been achieved by using susceptors which comprise molybdenum as refractory material. When molybdenum is used it is preferable that its purity is at least 99% and more preferable at least 99.7%.

The susceptor, reactor or furnace will preferably be arranged to operate at a slight angle to the horizontal so that material fed through the furnace at its upper end is assisted by gravity to move to the lower end. To further assist the progress of the material, means are provided to rotate the susceptor, reactor or furnace about its major axis. Furthermore, the inner surface of the susceptor, reactor or furnace is preferably formed with one or more protrusions to assist progress of the material which is being heated, such protrusion or protrusions being preferably in the form of one or more helical flanges. The protrusion or protrusions can be an integral part of the susceptor, or they can be attached to the susceptor.

Regarding the use of refractory materials in the furnace, it will be appreciated that the whole of the revolving part of the furnace should be very adequately supported in order to prevent undue stresses in the refractory material. This is important since any undue stress may also affect the coating material.

For such applications as waste disposal or for the processing of biomass material, it is also desirable to provide means for injecting air, oxygen, water, steam or other oxidizers or reducing agents such as hydrogen, hydrogen peroxide and hydrochloric acid, into the susceptor, reactor or furnace in order to control the chemistry of hydrolysis between 800° C. and 1700° C., preferably above 1000° C. of the particular operation which is being performed.

One possible furnace, e.g. an induction furnace, of the invention will now be illustrated by way of example with reference to the accompanying drawing in which:

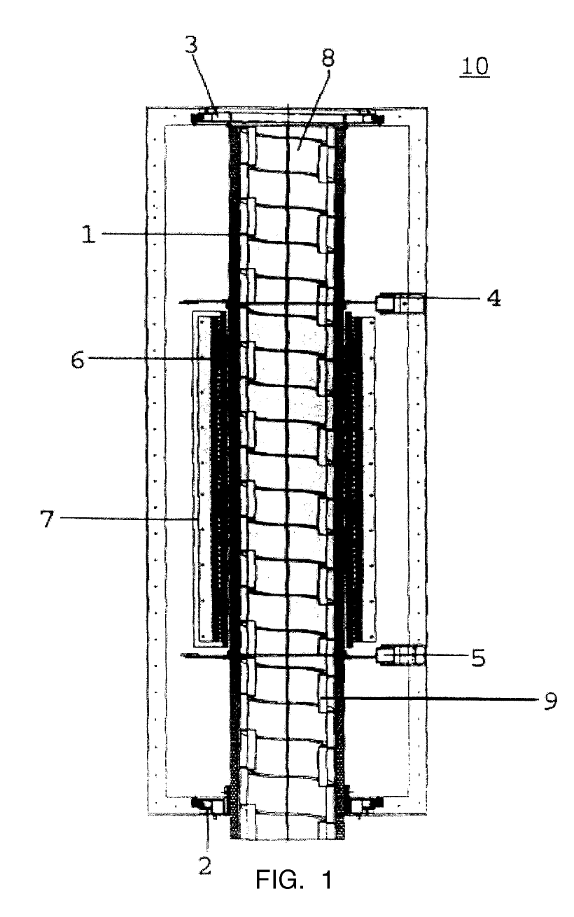

FIG. 1 is a vertical section of the main part of an induction furnace in accord with the present invention;

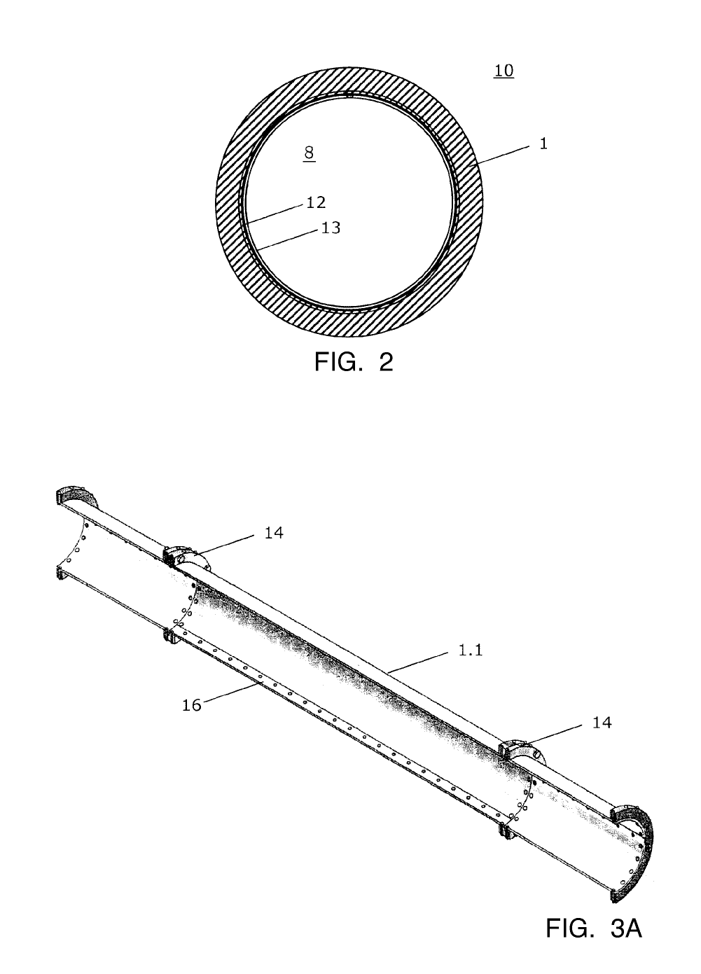

FIG. 2 is a cross-section of an inventive furnace;

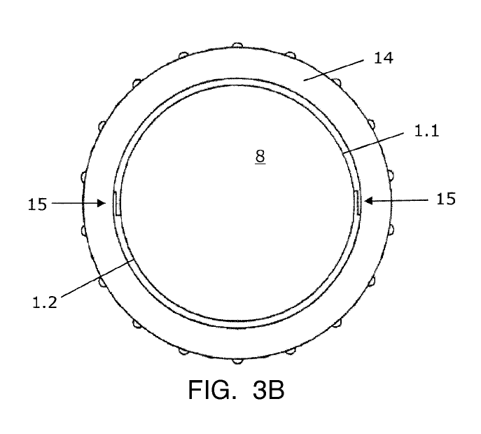

FIG. 3A is a perspective view of one segment of a susceptor, according to the present invention;

FIG. 3B is a cross-section of two segments forming a susceptor, according to the present invention.

### DETAILED DESCRIPTION

The present invention concerns high-temperature susceptors, reactors, furnaces and ovens. For the sake of simplicity, in the following, the word furnace is used as synonym for all the different kinds of high-temperature systems where the invention can be advantageously employed.

When referring to “high-temperatures”, temperatures above 800° C. and preferably above 1000° C. are meant. In some applications, the temperature can reach 1700° C.

In the furnace exemplified in FIG. 1, a cylinder 1 of a refractory material, e.g. a refractory metal, having a length of approximately 1-8 meters, an internal diameter of approximately 0.1-0.5 meters and an external diameter of approximately 0.12-0.52 meter, is employed. The cylinder 1 is held between two annular end plates 2, 3. The structure is positioned at a slight angle to the horizontal so that the plate 2 can be regarded as an upper end plate and the plate 3 can be regarded as the lower end plate. The cylinder 1 is held in position by two resistant rollers 4, 5, for instance.

Surrounding the cylinder 1 is an induction coil 6 having a length of approximately 0.5-4 meters and a thickness of approximately 0.015 meters, for instance. The induction coil 6 may be encased in a steel cover 7 so that the system occupies a gas-tight space surrounding the furnace chamber which can be filled with nitrogen or other inert gases.

To assist the movement of material which is being heat-treated through the furnace chamber 8, a helical protrusion 9 is formed integrating with the internal surface of the cylinder 1.

The whole structure is mounted at each end on bearings (not shown) to provide rotation, and rolling seals and airlocks (also not shown) are also fitted at both ends of the furnace. This ancillary equipment, along with the electrical circuitry of the induction heater and also the heat radiation detector means and related control equipment are all of a conventional nature and therefore need not be described in order to enable the skilled person to operate the new furnace structure of the invention.

According to a first embodiment of the present invention, a protective coating 11 is applied onto the refractory material. The refractory material may comprise molybdenum. The coating 11 comprises a Silicon-Boron (SiB) compound, respectively a Silicon-Boron-based layer. The protective Silicon-Boron coating 11 has the highest concentration at the inner wall of the furnace 10, since this portion of the wall is exposed to chemicals and/or oxygen.

According to a second embodiment of the present invention, a protective multi-layer coating 12, 13 is applied or coated onto inner the part of the refractory material which is exposed to chemicals and/or oxygen, as schematically illustrated in FIG. 2. FIG. 2 shows a cross-section of an inventive furnace 10. The multi-layer coating comprises a molybdenum compound or a high purity molybdenum layer 12, respectively a molybdenum-based layer 12 (e.g. a molybdenum alloy), and a Silicon-Boron (SiB) compound 13, respectively a Silicon-Boron-based layer 13. This stack of two layers 12, 13 is applied or coated onto the inner wall of the furnace 10, since this portion of the wall is exposed to chemicals and/or oxygen. A sintering process is preferably employed in order to provide for a stable connection of the materials mentioned.

Details of a segment 1.1 of a susceptor are depicted in FIG. 3A. Two such segments 1.1 and 1.2 can be connected in order to form a cylindrical susceptor 1. All parts (at least those that are inside the furnace) shown in FIGS. 3A and 3B may be coated or protected by the above-mentioned Silicon-Boron coating system. Flanges 14 may be used, as illustrated in FIG. 3A, in order to attach the different segment to each other. In FIG. 3B a cross-section is shown. As can be seen in the Figure, the two segments 1.1 and 1.2 that together for a cylinder 1, can be designed so that they overlap in areas 15. The two segments 1.1 and 1.2 for this purpose may comprise connecting flanges 16 where the respective connecting flange 16 of one segment 1.1 fits into the respective connecting flange of the other segment 1.2. Rivets may be used for instance to connect the respective elements.

A molybdenum susceptor combined with a Silicon-Boron (S—B) compound is very well suited for the purposes of the present invention since the Silicon-Boron coating forms kind of a diffusion zone or interface region which allows the coating remain intact while the susceptor expands or contracts when the temperature changes. This is very important, since otherwise internal stress would lead to cracks or weak spots. These cracks or weak spots would allow oxygen to attack the refractory material (e.g. comprising molybdenum).

Boron (B) is employed because it has properties which are borderline between metals and non-metals. Boron is a semiconductor rather than a metallic conductor. Chemically it is close to silicon (Si). Boron has the advantage that it is inert chemically and is resistant to attack by certain acids.

Instead of molybdenum (Mo) one could also use Hafnium (Hf) or a Hafnium alloy and/or Lanthan (La) or a Lanthan alloy. Also suited is Zirconium (Zr) or Tungsten (W) (also called wolfram). Also suited is Titanium-Zirconium-Molybdenum (TZM). A molybdenum alloy containing titanium, zirconium, hafnium, or caron can also be employed.

Very well suited is a protective coating where a first layer of molybdenum-based compound is situated on the refractory material and where a second Silicon-Boron-based layer is situated on the molybdenum-based compound layer.

The furnaces presented herein are well suited for creating Syngas (also called synthesis gas). The Syngas is a gas mixture that contains varying amounts of carbon monoxide (CO) and hydrogen (H₂) generated by the gasification of a carbon containing fuel, such as waste disposal, plants, wood, etc. The Syngas is provided at an output of the furnace 10. This output is not shown in any of the figures.

It will be understood that many variations could be adopted based on the specific structure hereinbefore described without departing from the scope of the invention as defined in the following claims.

1-12. (canceled)

13. A high-temperature furnace (10) with a wall (1) or chamber defining an inner zone (8), said wall (1) or chamber comprising a refractory material, characterized in that said refractory material comprises molybdenum or a molybdenum compound (12) being protected against oxygen in said inner zone (8) by means of a protective coating, said protective coating comprising a Silicon-Boron (SI—B) compound (13) for gasification of a carbon containing fuel, wherein at an output of said furnace (10) Syngas is provided.

14. The furnace (10) as claims in claim 1, wherein said molybdenum compound (12) is an alloy.

15. The furnace (10) as claimed in claim 1, wherein said Silicon-Boron (SI—B) compound (13) is an alloy.

16. The furnace (10) as claimed in claim 1, wherein the furnace is cylindrical in shape, the interior surface of the respective cylinder (1) foaming the lining of a furnace chamber defining said inner zone (B).

17. The furnace (10) as claimed in claim 1, comprising an induction heater (7).

18. The furnace (10) as claimed in claim 1, wherein said refractory material is a high purity molybdenum having a purity of at least 99% and more preferable at least 99.7%.

19. Use of high-temperature furnace (10) with a wall (1) or chamber defining an inner zone (8), said wall (1) or chamber comprising a refractory material, characterized in that said refractory material comprises molybdenum or a molybdenum compound (12) being protected against oxygen in said inner zone (8) by means of a protective coating, said protective coating comprising a Silicon-Boron (SI—B) compound (13)
in the disposal of waste materials, and/or
in the processing of biomass, such as plants, wood, and/or
in the conversion of organic materials into synthetic gas.

20. The use of claim 7, wherein an oxygen-free atmosphere is provided in said inner zone (8).

21. The use of claim 9, wherein temperature above 800° C. as preferably up to 1700° C. are reached in said inner zone (8).
